(19) United States
(12) Patent Application Publication
(10) Pub. No.: US 2011/0244556 A1
(43) Pub. Date: Oct. 6, 2011

(54) Process For Preparing Ganoderma Spore Oil

(76) Inventors: Yizheng Xie, Guangzhou (CN); Shenzhu Li, Guangzhou (CN); Burton B. Yang, Toronto (CA); Chong Li, Guangzhou (CN); Zhi Zhang, Guangzhou (CN); Qingping Wu, Guangzhou (CN); Guanzhou Chen, Guangzhou (CN); Biao Luo, Guangzhou (CN)

(21) Appl. No.: 12/302,026

(22) PCT Filed: May 24, 2007
(86) PCT No.: PCT/CN2007/001687

§ 371 Date: Dec. 4, 2008

(51) Int. Cl. C11C 1/00

(52) U.S. Cl. 435/271

(57) ABSTRACT

The present invention relates to a method for preparing Ganoderma spore oil which is in the field of biotechnology. The method includes using Ganoderma spore powder and Ganoderma powder (obtained from grinding fruiting bodies) as raw materials, applying enzymatic Ganoderma sporoderm broken methods, one-step granulation, supercritical CO₂ extraction method, as well as centrifugation and refining. The light yellow oleaginous substances obtained posses a variety of physiological functions such as strengthening immunity, protecting the liver and inhibiting tumor cell growth, etc. Ganoderma spore oil prepared with the present technology contains not only spore extracts, but also extracts from Ganoderma fruiting bodies and mycelium by CO₂ supercritical extraction, with more types of triterpenoids. The inhibitory effects of Ganoderma spore oil is a onefold higher than spore oil prepared from the physical preparation of the sporoderm-broken spore. Meanwhile, the problem of spore oil spoilage arising from oxidation is solved due to the low peroxide value within Ganoderma spore oil, and thereby the quality of Ganoderma spore oil is greatly improved.

### FIELD OF THE INVENTION

The present invention relates to an extraction method for preparing Ganoderma spore oil from sporoderm-broken Ganoderma spore powder and Ganoderma powder (obtained by grinding the fruiting bodies) by using CO₂ supercritical technology. The method provided is in the field of biotechnology.

### BACKGROUND OF THE INVENTION

Ganoderma [Ganoderma lucidum (Curt:Fr) P. Karst] is a precious Chinese traditional herb, which is a basidiomycetes fungus belonging to Ganodermaceae of Aphyllophorales, and Genus Ganoderma. Ganoderma spores are seeds of Ganoderma, which release at the pelius of mature Ganoderma lucidum. The spores are the essence of Ganoderma, containing the entire genetic materials and bioactive substances of Ganoderma. Many studies have showed that Ganoderma spores possess great variety of physiological activities such as strengthening body immunity, protecting the liver, antiviral, regulating blood lipid, and promoting nervous, cardiovascular and respiratory systems etc. Ganoderma spores are oval-shaped spores of 5-8 μm in size. Within the spores, there are 1-2 oil drops. Ganoderma spores have double-layered sporoderm consisting of chitin, lignin, cellulase, Si, Ca, Fe, Mg, Al and so on, which make Ganoderma spores firm and tenacious and have the characteristics of acid resisting, alkaline resisting, heating resisting, compression resisting, and being stable against digestive enzymes as well. Extraction of bioactive substances from Ganoderma spores thus becomes very difficult. In order to enhance bioavailability of Ganoderma spores, it's imperative to develop an effective wall-broken process for extracting bioactive components from Ganoderma spores. There have been lots of scientific reports on Ganoderma spore breaking methods. At present, Ganoderma spore wall breaking chiefly depends on a mechanical means including scissor-cutting, grinding, spray crushing, airstream crushing, microstream-impact crushing and so on. Superfine pulverization apparatus includes ball miller, high speed airstream crushing machine, roller, sprayer. Although the mechanical means is a simple and easy way to obtain high breaking ratio and practical for large scale industrial production, Ganoderma spore oil is apt to deteriorate from oxidation due to improper reprocess. Furthermore, the cost of operation is high because the complicated mechanical equipment is expensive. Enzymatic sporoderm breaking technology is an alternative method for breaking Ganoderma sporoderm. For example, Wang Cunxue et al. (2002) discloses a method by soaking Ganoderma spores in water for 12 hours to soften the cell walls of the spores and immersing the treated spores in 1.5% enzyme solution (cellulase or snail enzyme, etc.) at 35° C. for 3 hours, followed by grinding the spores for 10-12 minutes after being air-dried. Sporoderm breaking ratio is 95%. Xia zhilan et al. (2005) discloses a 40% of sporoderm breaking ratio obtained by treating the spores with ultrasonic wave alone for 5 minutes while a 98% of Ganoderma sporoderm breaking ratio reached by treating the spores with 3% lywallzyme at 38° C. for 4 hours before treating with ultrasonic wave for 5 minutes. Chinese Patent No. CN 00130883 discloses a 99% of Sporoderm breaking ratio reached by a method for extracting bioactive substances from germination-activated Ganoderma lucidum spores, by soaking the spores in water or biotin solution for 0.5-8 hours and incubating for 0.5-24 hours at a relative humidity of 65%-98% and temperature of 20° C.-48° C., then, using chitinase and cellulase to soften and break the cell walls of the spores, followed by applying a mechanical means such as superfine pulverization, rolling, and grinding.

The major components found in Ganoderma sporoderm-broken spores are triterpenoids and fatty acids, etc. As they are fat-soluble hydrocarbons and lipoids capable of dissolving in organic solvents such as CHCL₃, CH₃OH and in supercritical CO₂ fluids. As carbon dioxide's properties of colorless, tasteless, nontoxic, nonflammable, and non-explosive, which make organic solvent extraction safe and leave no chemical solvent residues, supercritical CO₂ extraction technology is suitable for the extraction of effective components from Ganoderma spores. Moreover, the extraction can be performed at low temperatures and it is unlikely that decomposition reactions could happen during extraction. Chinese Patent No. CN 1194079 discloses a Ganoderma spore oil preparation method composed of spore softening, granulating, and extracting in supercritical CO₂. As temperatures used for spore softening are as high as 80° C. to 140° C., oxidation may easily occur, causing the spoilage of the oleaginous substances within the sporoderm-broken spores. Thus, spore oil products produced by this method may have a poor quality. Chinese Patent No. CN1114446C discloses a method for extracting bioactive substances from Ganoderma spores. Two steps are included: breaking the cell walls of the spores and extracting spore oil by supercritical CO₂ extraction method. The extraction is carried out at a pressure of 5 MPa to 60 MPa, and a temperature of 32° C. to 85° C., CO₂ flow rate of 5 Kg/h to 80 Kg/h. However, high yielding and purity spore oil can hardly be obtained in large scale production under conditions of a wide range of temperatures and pressures. Chinese Patent No. CN1094766C discloses a method for preparing Ganoderma spore oil using supercritical CO₂ extraction, by mixing Ganoderma spores with mixtures of water and gelatin or starch, and granulating, followed by supercritical CO₂ extraction. This method is unsatisfactory for practical industrial production, for the supercritical extraction covers a wide range of temperatures and pressures. Besides, the extracting time is as long as 35 hours.

At present, Ganoderma spore oil extraction by supercritical CO₂ fluid technology is generally based on sporoderm-broken spores by mechanical means, or intact spores softening by high temperatures, followed by granulating and extraction. Ganoderma spore oil extracted from spores broken by mechanical means is of low physiological activities, and thereby with poor quality, because a part of the bioactive substances obtained are spoiled by oxidation during mechanical process.

### SUMMARY OF THE INVENTION

The purpose of the present invention is to provide a method for preparing Ganoderma spore oil with physiological activities.

The technical protocols comprising: Ganoderma spore powder 50-100% and Ganoderma powder 0-50% (by weight) are used as raw materials, enzymatic sporoderm breaking, one-step granulating, supercritical CO₂ extraction, followed by centrifuging and refining. A light yellow oleaginous substance was obtained.

Detailed procedures are as follow:
1. Sporoderm-broken by enzymes. The culture medium prepared by mixing Ganoderm spore powder 50-100%, Ganoderma powder (obtained by grinding the fruiting bodies) 0-50%, millet 0-10%, sorghum grain 0-10%, CaCO₃ 0-5%, sucrose 0-5%, VitB₁ 0-1% (by weight). Water was added to the medium at a ratio of 1:1-1.5 and blended, followed by addition of HCl or NaOH to adjust PH to 5.0-6.5. The medium was autoclaved at 0.15 MPa for 1.5-2.5 h. After the sterilized medium completely cooled, they were inoculated with Ganoderma spawn (solid or liquid) in a sterile room and incubated at 15° C.-35° C. until the cultures were fully grown with mycelium. Sporoderm was digested mildly by enzyme complex including cellulase, protease and pectinase etc. which continuously released during mycelial growth. 0-60 days later, the cultures were harvested, dried and crushed. Superfine pulverization apparatus such as ball miller, high speed airstream crushing machine, roller, sprayer was used to improve the sporoderm broken ratio to over 95%.
2. Granulating. The purpose of granulating is to avoid Ganoderma spores entering the pipes and causing overpressure during extraction. The enzyme-treated sporoderm broken spores were granulated by a one-step granulator, with pure water serving as adhesive agent. Drying temperatures were maintained at 30° C.-50° C. and drying duration was 2-4 h. Ganoderma spore granules with water contents less than 5% were obtained.
3. Supercritical CO₂ extraction. The granulated Ganoderma spores were put in the extractor of a supercritical CO₂ fluid extraction apparatus. Extraction were conducted at 20-40 MPa and 20-50° C., with a CO₂ flow rate of 60-150 L/h. Primary separation was performed at 8-10 MPa and 20° C.-45° C. Secondary separation was performed at 5-8 MPa and 30° C.-50° C. Anhydrous alcohol and acetic ether were added at the amount of 5-100% (v/w) during supercritical CO₂ extraction.
4. Refining. Extracts were harvested. Impurities from the spore powders were removed by filtration and water removed by centrifugation at 5000-20000 rpm. A clear and transparent light yellow oleaginous substance was obtained, with an oil extraction rate of 10-25%.

Comparisons on inhibitory effect of tumor cell growth and peroxide value were made between Ganoderma spore oil prepared with the present technology and spore oil prepared from the conventional physical preparation of the sporoderm-broken spores.

Samples: (1) Ganoderma spore oil prepared with the technology described above (2) Ganoderma spore oil prepared from the conventional physical preparation of the sporoderm-broken spores. The sporoderm of G. lucidum spores were broken by grinding the spores with an ultra smashing machine for 30-40 min. The rest procedures of granulating, extracting, and refining were the same as (1).
1. A Comparison of inhibitory effects of Ganoderma spore oil prepared with the present technology on tumor cell growth with spore oil prepared from the conventional physical preparation of the sporoderm-broken spores
   Sample treatment: both samples were emulsified with glycerin solution to a concentration of 8 μl/mL. Human malignant breast carcinoma cells (MT-1) were obtained from Department of Laboratory Medicine and Pathobiology, University of Toronto, Canada. Cell culture: Cells were maintained in DMEM containing 10% fetal bovine serum (FBS), 100 IU/mL penicillin, 100 IU/mL streptomycin.
   Methods: (1) Human malignant breast carcinoma cells (MT-1) were seeded on 12-well tissue culture plates at a density of 1.0×10⁵ cells/ml. The inoculum amount was 1 mL. The cell cultures were maintained in a tissue culture incubator at 37° C. containing 5% CO₂ for 5 hours. (2) Solutions of Ganoderma spore oil (prepared from the present technology) were added to the MT-1 tissue culture plates at the amount of 0, 40, 80, 120, 160 μl, and maintained in a tissue culture incubator at 37° C. containing 5% CO₂ for 2 days. Ganoderma spore oil prepared from the conventional physical preparation of the sporoderm-broken spores were added to the MT-1 tissue culture plates at the amount of 0, 40, 80, 120, 160, 200, 240, 280 μl and maintained in a tissue culture incubator at 37° C. containing 5% CO₂ for 2 days. (3) Cells were harvested from CO₂ incubator. The attached living cells were fixed and stained with Diff-quik Differential Staining Set and examined and under a light microscope and photographed. The cell number was counted.
   Results: See FIGS. 1 and 2. With the increasing of Ganoderma spore oil concentration, tumor cell growth was inhibited and living tumor cells slowly decreased in number. The inhibitory effect of Ganoderma spore oil (prepared with the present technology) at a concentration of 160 μl is similar to spore oil prepared from the physical preparation of the sporoderm-broken spores at a concentration of 280 μl. The experimental results showed that Ganoderma spore oil prepared with the present technology had much greater inhibitory effects on tumor cell growth than spore oil prepared from the physical preparation of the sporoderm-broken spores.
2. Comparison of peroxide value (POV)
   POV was tested by the method described in GB/T5009.37. The POV was 0.08-0.10 (g/100 g) in Ganoderma spore oil prepared with the present technology and over 0.13 (g/100 g) in spore oil prepared from the physical preparation of the sporoderm-broken spore. The POV in Ganoderma spore oil prepared with the present technology was significantly lower than spore oil prepared from the physical preparation of the sporoderm-broken spore, indicating that Ganoderma spore oil prepared with the present technology has much stronger antioxidative activities.
      Meanwhile, Ganoderma spore oil prepared with the present technology possesses the effects of strengthening immunity and protecting the liver. It can be used as raw materials for producing health products and pharmaceuticals as well as high grade cosmetics. Its functions have been proved by the following experiments.
      Sample: “Ganoderma Spore Oil Soft Capsule” was produced from Ganoderma spore oil prepared with the present technology described above and the production procedures met GMP requirements as well. For pharmaceutical function tests, the daily dosage recommended was 0.033 g/kg BW, based on 60 kg BW (adults).
      Treatment group and dosage: corn oil group (control), low dosage group, moderate dosage group, and high dosage group were divided. Dosage: low dosage group, 0.17 g/kg BW (5 times of the recommended daily dosage); moderate dosage group, 0.33 g/kg BW (10 times of the recommended daily dosage); high dosage group, 1.0/kg BW (30 times of the recommended daily dosage).
      Animal: Kunming (SPF) female mice, aged 6-8 weeks, weighing 18-22 g.
      Administration: The mice were perfused with 0.1 ml/10 g (BW) Ganoderma spore oil daily.

### Results:

### 1. Effects of “Ganoderma Spore Oil Soft Capsule” on Delayed Hypersensitivity (DTH) in Mice (See Table 1)

TABLE 1
Effect of “Ganoderma Spore Oil Soft Capsule” on delayed
hypersensitivity (DTH) in mice

| | | | Increase of | P value |
|---|---|---|---|---|
| | Dosage | Number | the thickness | (as compared |
| | g/kg | of | of feet | with the |
| Group | BW | animal | (mm) | Control group) |
| Control | 0.00 | 12 | 0.28 ± 0.14 | |
| Low dosage | 0.17 | 12 | 0.35 ± 0.13 | >0.05 |
| Moderate dosage | 0.33 | 12 | 0.35 ± 0.24 | >0.05 |
| High dosage | 1.00 | 12 | 0.54 ± 0.16 | <0.01 |
| F value | | | 5.116 (P < 0.01) | |

### 2. Effect of “Ganoderma Spore Oil Soft Capsule” on the Transformation of Murine Spleen Lymphocytes Induced by Con A (See Table 2)

TABLE 2
Effect of Ganoderma Spore Oil Soft Capsule” on the transformation of
murine spleen lymphocytes induced by Con A

| | | | | P value |
|---|---|---|---|---|
| | Dosage | | | (as compare with |
| | g/kg | Number of | | the control |
| Group | BW | animal | OD value | group) |
| Control | 0.00 | 12 | 0.145 ± 0.053 | |
| Low dosage | 0.17 | 12 | 0.166 ± 0.043 | >0.05 |
| Moderate | 0.33 | 12 | 0.231 ± 0.054 | <0.01 |
| dosage | | | | |
| High dosage | 1.00 | 12 | 0.221 ± 0.052 | <0.01 |
| F value | | | 8.281 (P < 0.01) | |

### 3. Effect of “Ganoderma Spore Oil Soft Capsule” on NK Cell Activities in Mice (See Table 3)

TABLE 3
Effect of “Ganoderma Spore Oil Soft Capsule” on
NK cell activities in mice

| | | | | P value |
|---|---|---|---|---|
| | Dosage | NK cell | Transformation | (as compared |
| | g/kg | activity | value of NK cell | with the |
| Group | BW | (%) | activity | control group) |
| Control | 0.00 | 8.03 ± 0.93 | 0.29 ± 0.02 | |
| Low dosage | 0.17 | 8.39 ± 1.09 | 0.29 ± 0.02 | >0.05 |
| Moderate | 0.33 | 9.38 ± 1.09 | 0.31 ± 0.02 | <0.05 |
| dosage | | | | |
| High dosage | 1.00 | 9.76 ± 1.75 | 0.32 ± 0.03 | <0.01 |
| F value | | | 4.485 (P < 0.05) | |

### 4. Effects of “Ganoderma Spore Oil Soft Capsule” on Serum ALT and AST in Mice (See Tables 4 and 5)

TABLE 4
Effects of “Ganoderma Spore Oil Soft Capsule” on serum ALT

| | | | | P value |
|---|---|---|---|---|
| | Dosage | Number | | (as compared |
| | g/kg | of | | with the |
| Group | BW | animal | OD value | control group) |
| Blank Control | 0.00 | 12 | 25.17 ± 3.27 | 3.22 ± 0.13 |
| CCl₄ control | 0.00 | 12 | 7373.1 ± 4133.55 | 8.72 ± 0.68ΔΔ |
| Low dosage | 0.17 | 12 | 1320.92 ± 938.66 | 6.97 ± 0.70** |
| Moderate | 0.33 | 12 | 1517.58 ± 983.07 | 7.16 ± 0.58** |
| dosage | | | | |
| High dosage | 1.00 | 12 | 1647.17 ± 891.93 | 7.31 ± 0.41** |

Note:
1. t value = −27.750, P < 0.01, T test after logarithmic transformation of serum ALT levels in the blank control group and CCl₄ control group.
2. F value = 21.126, P < 0.01, Variance analysis (ANOVA) after logarithmic transformation of serum ALT levels in various dosage group and CCl₄ control group.
3. ΔΔ indicates comparisons between CCl₄ control group and the blank control group, P < 0.01;
**indicates comparisons between various dosage group and CCl₄ control group, P < 0.01

TABLE 5
Effect of “Ganoderma Spore Oil Soft Capsule” on serum AST

| | | | | P value |
|---|---|---|---|---|
| | Dosage | | | (as compared |
| | g/kg | Number of | | with the |
| Group | BW | animal | OD value | control group) |
| Blank Control | 0.00 | 12 | 108.67 ± 14.00 | 4.68 ± 0.13 |
| CCl₄ control | 0.00 | 12 | 3890.2 ± 2304.64 | 8.06 ± 0.74ΔΔ |
| Low dosage | 0.17 | 12 | 678.17 ± 477.87 | 6.34 ± 0.60** |
| Moderate | 0.33 | 12 | 743.50 ± 569.58 | 6.43 ± 0.59** |
| dosage | | | | |
| High dosage | 1.00 | 12 | 914.83 ± 617.12 | 6.67 ± 0.54** |

Note:
1. t value = −15.561, P < 0.01, T test after logarithmic transformation of serum AST levels in the blank control group and CCl₄ control group.
2. F value = 19.876, P < 0.01, Variance analysis (ANOVA) after logarithmic transformation of serum AST levels in various dosage group and CCl₄ control group.
3. ΔΔ indicates comparisons between CCl₄ control group and the blank control group, P < 0.01:
**indicates comparisons between various dosage group and CCl₄ control group, P < 0.01

### 5. Effects of “Ganoderma Spore Oil Soft Capsule” on the Scoring of Different Liver Histopathologic Types in Mice (See Table 6)

TABLE 6
Effect of “Ganoderma Spore Oil Soft Capsule” on the
scoring of different liver histopathologic types in mice

| | | Number | | | Plasma | | |
|---|---|---|---|---|---|---|---|
| | Dosage | of | Ballooning | | condensation | Hydropic | Cell |
| Group | g/kg BW | animal | degeneration | Steatosis | (mean rank) | degeneration | necrosis |
| Control | 0.00 | 12 | 13.50 | 30.00 | 26.50 | 30.50 | 23.00 |
| CCl₄ | 0.00 | 12 | 37.75ΔΔ | 30.00 | 31.50 | 30.50 | 46.08ΔΔ |
| control | | | | | | | |
| Low dosage | 0.17 | 12 | 36.25 | 30.00 | 34.00 | 30.50 | 25.17** |
| Moderate | 0.33 | 12 | 30.13 | 30.00 | 29.00 | 30.50 | 28.21* |
| dosage | | | | | | | |
| High | | 12 | 34.88 | 30.00 | 31.50 | 30.50 | 30.04** |
| dosage | | | | | | | |

Note:
1. Rank test. Hepatic ballooning degeneration, steatosis, plasma condensation, hydropic degeneration, cell necrosis were grading data.
2. ΔΔindicates comparisons between CCl₄ control group and the blank control group, P < 0.01;
*indicates comparisons between various dosage group and CCl₄ control group, P < 0.05;
**indicates comparisons between various dosage group and CCl₄ control group, P < 0.01.

### 6. Conclusion

The mice were continuously administered with 0.17, 0.33, 1.00 g/kg (BW) “Ganoderma Spore Oil Soft Capsule” for 4 weeks (5, 10, 30 times respectively of the recommended daily dosage). The results showed:
(1) Delayed hypersensitivity (DTH) in mice using sheep red blood cell (SRBC) and Con A inducing murine spleen lymphocytes transformation was positive, indicating that “Ganoderma Spore Oil Soft Capsule” possessing the effect of enhancing immunity
(2) NK cell activity test in mice was positive, indicating “Ganoderma Spore Oil Soft Capsule” possessing the effect of promoting NK cell activities;
(3) The level of serum ALT and AST in various dosage groups were reduced as compared with the CCL₄ control group, with significant differences. The result of ALT and AST examination were positive.
(4) The histopathologic changes of liver were reduced as compared with the CCl₄ control group, with significant differences. The result of histopathologic examination was positive.

Base on “Technological Criterion of Test and Assessment on Health Food” (2003) by Ministry of Health of People's Republic of China, an assessment can be made that “Ganoderma Spore Oil Soft Capsule” possess functions of strengthening immunity and protecting against the chemical injury of the liver.

Ganoderma mycelium, fruiting bodies and spores generate in different growth stages of Ganoderma lucidum which needs various nutrients for their growth. Naturally, the bioactive components and their contents containing in Ganoderma mycelium, fruiting bodies and spores are different. Ganoderma spore oil prepared by using Ganoderma spore powder and Ganoderma powder (obtained by grinding the fruiting bodies) as raw materials, applying enzymatic sporoderm broken method and supercritical CO₂ extraction technology. Ganoderma Sporoderm was digested mildly by enzyme complex continuously released from the mycelium. Therefore, the spoilage of bioactive components causing by oxidation can be avoided. Besides, there will be more effective components extracted from the fruiting bodies and the mycelium. Hence, Ganoderma spore oil prepared with the present technology contains not only extracts from Ganoderma spores, but also extracts from the fruiting bodies and mycelium as well, with more types of triterpenoids and much stronger health functions such as strengthening immunity, protecting the liver and inhibiting tumour cell growth, etc. Furthermore, the problem of spore oil spoilage arising from oxidation can be solved due the low peroxide value within Ganoderma spore oil.

### BRIEF DESCRIPTION OF THE DRAWINGS

FIG. 1: Inhibitory effect of Ganoderma spore oil (prepared with the present technology) on human malignant breast carcinoma cells (MT-1). With the increasing of Ganoderma spore oil concentration, tumor cell growth was inhibited and living tumor cells slowly decreased in number. There was only a few tumor cells alive when the concentration of Ganoderma spore oil was 160 μl.

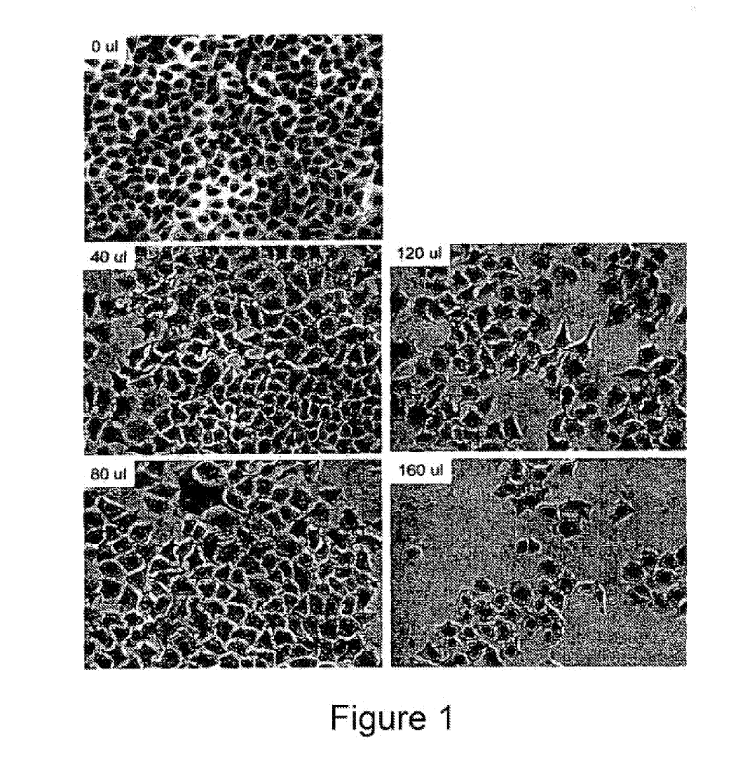

FIG. 2: Inhibitory effect of G. spore oil prepared from the physical preparation of the sporoderm-broken spore on human malignant breast carcinoma cells (MT-1). With the increasing of Ganoderma spore oil concentration, tumor cell growth was inhibited and living tumor cells slowly decreased in number. There was only a few tumor cells alive when the concentration of Ganoderma spore oil was 2804

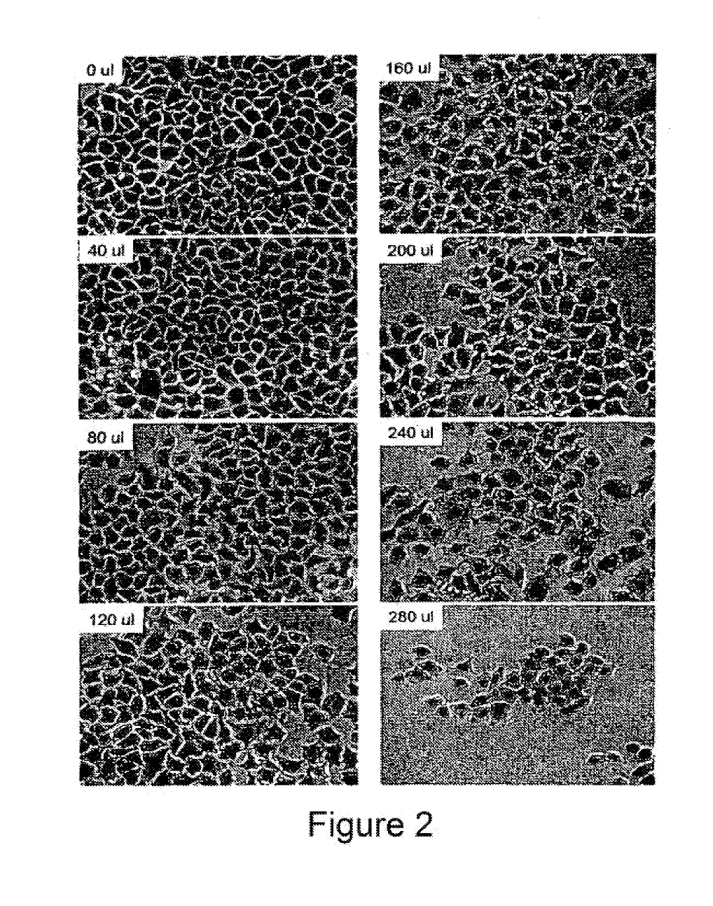

### DETAILED DESCRIPTION OF THE PREFERRED EMBODIMENT

### Example 1

### Process 1 for Ganoderma spore oil preparation

(1) Sporoderm breaking by enzymatic methods. The culture medium was prepared by mixing Ganoderma spore powder (obtained by grinding the fruiting bodies) 50%, Ganoderma powder 30%, millet 10% (soaked overnight and washed), sorghum grain 10% (soaked overnight and washed). Pure water was added to the medium at a ratio of 1:1.2 and blended, followed by addition of HCl to adjust PH to 5.5. The culture medium was autoclaved at 0.15 MPa for 2 h. After the sterilized medium completely cooled, they were inoculated with Ganoderma spawn in a sterile room and incubated at 30° C. until the cultures were fully grown with mycelium. 20 days later, the cultures were harvested and dried, crushing with a ball miller for 10 min.

(2) Granulating. The enzyme-treated sporoderm broken spores were granulated by a one-step granulator, with pure water serving as adhesive agent. Drying temperature was maintained at 40° C. Drying duration was 2.5 h. 20 mesh Ganoderma sporoderm broken spore granules with water content Less than 5% were obtained.

(3) Supercritical CO₂ extraction. The granulated Ganoderma spores were put in the extractor of a supercritical CO₂ fluid extraction apparatus. Extraction was conducted at 20 MPa and 45° C., with a CO₂ flow rate of 60 L/h. Extracting duration was 6 h. Primary separation was performed at 10 MPa and 25° C. Secondary separation was performed at 8 MPa and 30° C.

(4) Refining. Extracts were harvested. Impurities from the spore powder were removed by paper filtration, and followed by centrifugation at 5000 rpm. A clear and transparent light yellow oleaginous substance was obtained.

### Example 2

### Process 2 for Ganoderma Spore Oil Preparation

(1) Sporoderm breaking by enzymatic methods. The culture medium prepared by mixing Ganoderma spore powder (obtained by grinding the fruiting bodies) 70%, Ganoderma powder 20%, millet 5% (soaked overnight and washed), CaCO₃ 2%, sucrose 2.5%, VitB₁ 0.5%. Pure water was added to the medium at a ratio of 1:1.2 and blended, followed by addition of HCl to adjust PH to 5.5. The culture medium was autoclaved at 0.15 MPa for 2 h. After the sterilized medium completely cooled, they were inoculated with Ganoderma spawn in a sterile room and incubated at 25° C. until the cultures were fully grown with mycelium. 40 days later, the cultures were harvested and dried, crushing with an ultra smashing machine for 10 min. Wall-broken ratio was over 95% as determined by hemacytometer count under a microscope.

(2) Granulating. The enzyme-treated sporoderm broken spores were granulated by a one-step granulator, with pure water serving as adhesive agent. Drying temperature was maintained at 30° C. Drying duration was 3.5 h. 60 mesh Ganoderma sporoderm broken spore granules with water content less than 5% were obtained.

(3) Supercritical CO₂ extraction. The granulated Ganoderma spores were put in the extractor of a supercritical CO₂ fluid extraction apparatus. Extraction was conducted at 25 MPa and 45° C., with a CO₂ flow rate of 80 L/h. Extracting duration was 3 h. Primary separation was performed at 8 MPa and 30° C. Secondary separation was performed at 5 MPa and 40° C.

(4) Refining. Extracts were harvested. Impurities from the spore powder were removed by vacuum filtration, and followed by centrifugation at 10000 rpm. A clear and transparent light yellow oleaginous substance was obtained.

### Example 3

### Process 3 for Ganoderma Spore Oil Preparation

(1) Sporoderm breaking by enzymatic methods. The culture medium prepared By mixing Ganoderma spore powder 90%, Ganoderma powder (obtained by grinding the fruiting bodies) 10%. Pure water was added to the medium at a ratio of 1:1.2 and blended. The culture medium was autoclaved at 0.15 MPa for 2 h. After the sterilized medium completely cooled, they were inoculated with Ganoderma solid spawn in a sterile room and incubated at 20° C. until the cultures were fully grown with mycelium. The cultures were harvested and dried, crushing with a ball miller for 20 min.

(2) Granulating. The enzyme-treated sporoderm broken spores were granulated by a one-step granulator, with pure water serving as adhesive agent. Drying temperature was maintained at 45° C. Drying duration was 2 h. 20 mesh Ganoderma sporoderm broken spore granules with water content less than 5% were obtained.

(3) Supercritical CO₂ extraction. The granulated Ganoderma spores were put in the extractor of a supercritical CO₂ fluid extraction apparatus. Extraction was conducted at 40 MPa and 50° C., with a CO₂ flow rate of 150 L/h. Extracting duration was 2 h. Acetic ether, serving as entrainer, was added at the amount of 20% (v/w) during supercritical CO₂ extraction. Primary separation was performed at 8 MPa and 45° C. Secondary separation was performed at 8 MPa and 40° C.

(4) Refining. Extracts were harvested. Impurities from the spore powder were removed by vacuum filtration, and followed by centrifugation at 20000 rpm. A clear and transparent light yellow oleaginous substance was obtained.

### Example 4

### Process 4 for Ganoderma Spore Oil Preparation

(1) Sporoderm breaking by enzymatic methods. The culture medium prepared by 100% Ganoderma spore powder. Pure water was added to the medium at a ratio of 1:1.15 and blended, followed by addition of HCl to adjust PH to 6.0. The culture medium was autoclaved at 0.15 MPa for 2 h. After the sterilized medium completely cooled, they were inoculated with Ganoderma liquid spawn in a sterile room and incubated at 28° C. until the cultures were fully grown with mycelium. 60 days later the cultures were harvested, dried and crushed.

(2) Granulating. The enzyme-treated sporoderm broken spores were granulated by a one-step granulator, with pure water serving as adhesive agent. Drying temperature was maintained at 35° C. Drying duration was 3 h. 40 mesh Ganoderma sporoderm broken spore granules with water content less than 5% were obtained.

(3) Supercritical CO₂ extraction. The granulated Ganoderma spores were put in the extractor of a supercriticalCO₂ fluid extraction apparatus. Extraction was conducted at 28 MPa and 40° C., with a CO₂ flow rate of 90 L/h. Extracting duration was 4 h. Primary separation was performed at 9 MPa and 35° C. Secondary separation was performed at 7 MPa and 45° C.

(4) Refining. Extracts were harvested. Impurities from the spore powder were removed by paper filtration, and followed by centrifugation at 8000 rpm. A clear and transparent light yellow oleaginous substance was obtained.

1. A method for preparing Ganoderma spore oil comprising:
raw materials: Ganoderma spore powder 50-100%, Ganoderma lucidum powder (obtained by grinding the fruiting bodies), 0-50% (by weight), breaking sporoderm of said Ganoderma spores by enzymatic methods, one-step granulating of said sporoderm broken spores with pure water serving as adhesive agent, extracting a light yellow oleaginous substance from said granulated sporoderm broken spores by a supercritical fluid carbon dioxide extraction method and followed by centrifugation and refining.

2. The method according to claim 1, wherein said raw materials are mixed with millet 0-10%, sorghum 0-10%, CaCO₃ 0-5%, sucrose 0-5%, Vit B₁ 0-1%.

3. The method according to claim 1, wherein said raw materials are blended with water at a ratio of 1:1-1:1.5 and autoclaved, after the sterilized medium completely cooled, they are inoculated with Ganoderma spawn in a sterile room and incubated at 15-35° C. until the cultures are fully grown with mycelium, 0-60 days later, the cultures are harvested, dried and crushed.

4. The method according to claim 3, wherein said crushing machine for said cultures crushing is at least one selected from the group consisting of ball-miller, roller, high speed airstream crushing machine etc.

5. The method according to claim 1, wherein said sporoderm-broken Ganoderma spores are granulated by a one-step granulator with pure water serving as adhesive agent, at a drying temperature of 30-50° C., drying duration 2-4 hours, Ganoderma spore granules with a moisture content less than 5% are obtained.

6. According to claim 1 wherein said extraction pressure is 20-40 MPa, said extraction temperature is 20-50° C., said CO₂ flow rate is 60 L/h-150 L/h, said extraction time is 0.5-6 h, said primary separation pressure is 8-10 MPa and said temperature is 25-45° C., said secondary separation pressure if 5-8 MPa and temperature 30-50° C.

7. According to claim 1, anhydrous alcohol or acetic ether, serving as entrainer, was added at the mount of 5-100% (v/w) during said supercritical CO₂ extraction.
